(19) United States
(12) Patent Application Publication
(10) Pub. No.: US 2008/0042738 A1
(43) Pub. Date: Feb. 21, 2008

(54) Internal voltage generator for use in semiconductor device

(75) Inventor: Khil-Ohk Kang, Kyoungki-do (KR)

Correspondence Address: MCDERMOTT WILL & EMERY LLP, 600 13TH STREET, N.W., WASHINGTON, DC, 20005-3096, US

(73) Assignee: HYNIX SEMICONDUCTOR INC.

(21) Appl. No.: 11/647,265

(22) Filed: Dec. 29, 2006

(30) Foreign Application Priority Data
Jun. 30, 2006 (KR) 2006-0060055

(51) Int. Cl. G05F 1/10

(52) U.S. Cl. 327/540

(57) ABSTRACT

An internal voltage generator is used in a semiconductor device. The generator includes a core voltage end, a first reference voltage generator for generating a first reference voltage, a second reference voltage generator having a test/option processor for generating a second reference voltage having a voltage level higher than that of the first reference voltage and setting the second reference voltage to one of a plurality of voltage levels, a core voltage driving unit for driving a voltage at the core voltage end based on the first reference voltage, and a core voltage discharger for discharging the voltage at the core voltage end based on the second reference voltage.

### CROSS-REFERENCE TO RELATED APPLICATION

The present invention claims priority of Korean patent application number 10-2006-0060055, filed on Jun. 30, 2006, which is incorporated by reference in its entirety.

### BACKGROUND OF THE INVENTION

The present invention relates to semiconductor design technologies; and, more particularly, to an internal voltage generator for use in a semiconductor device, which is capable of stably generating a core voltage to be applied to an internal circuit of the device.

The cell size of a semiconductor device has become smaller as the device is more highly integrated. Also, operating voltage is becomes lowered appropriately for such a small-sized cell. On the other hand, most of semiconductor devices employ an external power supply voltage supplied, but such a power supply voltage may incur noise and that causes change in its level. Therefore, an internal voltage generator is provided within a device to generate a stable internal voltage so that stable operation is always performed even with changes of the external power supply voltage.

FIG. 1 is a block diagram of a conventional internal voltage generator.

Referring to FIG. 1, the internal voltage generator 110 for applying a core voltage VCORE to an internal circuit 100 includes a sense amplifier over driving unit 111, a core voltage driving unit 112, a core voltage discharger 113 and a reference voltage generator 114.

An internal reference voltage VR, which is a high voltage that may vary with a process, is divided by a semiconductor device to provide several reference voltages. Control signals TRIM1, TRIM2 and TRIM3 refer to control signals for generating a predetermined supply reference voltage VREF based on the internal reference voltage VR. There are provided only three control signals TRIM1, TRIM2 and TRIM3 for convenience of explanation, but they may vary in number depending on the circuit configuration. The supply reference voltage VREF generally has a ½ voltage level of the required target core voltage VCORE (hereinafter, “half core voltage”).

As circuit configurations of the sense amplifier over driving unit 111, the core voltage driving unit 112 and the core voltage discharger 113 are already well-known in the art, detailed description thereof will be omitted. The circuit configuration of the reference voltage generator 114 that is closely related to the present invention is described in detail below.

The following is a brief description on the configurations of the sense amplifier over driving unit 111, the core voltage driving unit 112 and the core voltage discharger 113.

The sense amplifier over driving unit 111 serves to have a short circuit between an external power supply voltage VDD and a core voltage end VCORE and apply the external power supply voltage VDD directly to the core voltage end VCORE so that the sufficient core voltage VCORE is supplied to the internal circuit 100 when an activation signal Act (not shown) for activating the operation of Dynamic Random Access Memory (DRAM) is applied thereto.

The core voltage driving unit 112 compares the supply reference voltage VREF with the half core voltage of the core voltage VCORE and charges the core voltage VCORE when the half core voltage is lower than the supply reference voltage VREF.

The core voltage discharger 113 compares the supply reference voltage VREF with the half core voltage and discharges the core voltage VCORE when the half core voltage is higher than the supply reference voltage VREF.

The reference voltage generator 114 divides an input internal reference voltage VR and provides a required voltage level among divided reference voltages as the supply reference voltage VREF in response to control signals TRIM1, TRIM2 and TRIM3.

FIG. 2 is a detailed circuit diagram for describing the reference voltage generator 114 shown in FIG. 1.

With reference to FIG. 2, the reference voltage generator 114 is provided with a voltage divider 200 for taking and dividing the internal reference voltage VR, and a reference voltage output unit 210 for outputting any one of voltage levels at nodes N1 to N3 of the voltage divider 200 as the supply reference voltage VREF in response to the first to third control signals TRIM1, TRIM2 and TRIM3.

To be more specific, the voltage divider 200 is composed of a plurality of resistors R1 to R4 coupled in series between the internal reference voltage VR and a ground voltage VSS, wherein voltage levels into which the internal reference voltage VR is divided are provided onto each of the nodes N1 to N3.

The reference voltage output unit 210 is composed of inverters INV1 to INV3 that receive the first to third control signal TRIM1, TRIM2 and TRIM3, and first to third transfer gates G1, G2 and G3 that are operated under the control of the first to third control signals TRIM1, TRIM2 and TRIM3 and output signals of the corresponding inverters INV1, INV2 and INV3.

For example, if a voltage level at the second node N2 has the supply reference voltage VREF as required, the second control signal TRIM2 is set to logic high and the first and third control signals TRIM1 and TRIM3 are set to logic low, respectively. Thus, only the second transfer gate G2 is enabled to output the voltage level at the second node N2 as the supply reference voltage VREF. The supply reference voltage VREF is then provided to the core voltage driving unit 112 and the core voltage discharger 113

Similarly, with regard to the voltage levels generated at the first node N1 and the third node N3, the voltage level at the node N1 or N3 may be provided as the supply reference voltage VREF as required in response to the first to third control signals TRIM1, TRIM2 and TRIM3.

FIG. 3 is a diagram of simulation results of input/output signals of the reference voltage generator 114 depicted in FIG. 1.

Referring to FIG. 3, the supply reference voltage VREF is a voltage into which the internal reference voltage VR is divided, and has a voltage level lower than that of the internal reference voltage VR.

FIGS. 4A to 4C are waveform diagrams for describing a level displacement of the core voltage VCORE created according to the prior art.

Referring to FIGS. 1 and 4A, when an activation signal Act for activating the operation of DRAM is input, the core voltage VCORE is decreased by operation of the internal circuit 100, and the sense amplifier over driving unit 111 and the core voltage driving unit 112 charge the decreased core voltage VCORE. After that, the core voltage discharger 113 compares the supply reference voltage VREF with the half core voltage and discharges the core voltage VCORE when the half core voltage is higher than the supply reference voltage VREF.

At this time, the core voltage VCORE discharges beyond a target value due to a response speed delay of the core voltage discharger 113. The discharged core voltage VCORE is again charged by the core voltage driving unit 112. For the above reason, the core voltage VCORE has an unstable waveform similar to a saw tooth due to the repetitive charging and discharging operations on the basis of the predetermined target value.

Further, FIGS. 4B and 4C show that when a current is supplied from the sense amplifier over driving unit 111 and the core voltage driving unit 112 to the core voltage end, an improper current occurs due to skew of transistors during a process. That is, FIG. 4B represents that the current supplied to the core voltage end is much larger than that used in the internal circuit 110. In this case, the core voltage discharger 113 does not discharge a desired amount of current for a predetermined time period.

FIG. 4C shows that the current supplied to the core voltage end is slightly larger than that used in the internal circuit 110. In this case, the core voltage discharger 113 is excessively operated and thus discharges more current, which has a sawtooth-shaped unstable waveform as shown in FIG. 4A.

As described above, in the conventional internal voltage generator 110, the single supply reference voltage VREF generated by the reference voltage generator 114 is applied to the core voltage driving unit 112 and the core voltage discharger 113. Therefore, the core voltage VCORE has an unstable voltage level due to the repetitive charging and discharging operations by the response speed delay of the core voltage discharger 113.

If the current supplied to the core voltage end is affected by skew of transistors during a process, the required core voltage VCORE may not be generated, thereby making the operation of internal circuit 100, using such core voltage VCORE, unstable.

### SUMMARY OF THE INVENTION

It is, therefore, an object of the present invention to provide an internal voltage generator for a semiconductor device for generating a discharge reference voltage in response to speed delay of a core voltage discharger. The discharge reference voltage is set to a required voltage level depending on an amount of current supplied to a core voltage end.

In accordance with the present invention, there is provided an internal voltage generator for use in a semiconductor device, including: a core voltage end; a first reference voltage generator for generating a first reference voltage; a second reference voltage generator including a test/option processor for generating a second reference voltage having a voltage level higher than that of the first reference voltage and setting the second reference voltage to one of a plurality of voltage levels; a core voltage driving unit for driving a voltage at the core voltage end based on the first reference voltage; and a core voltage discharger for discharging the voltage at the core voltage end based on the second reference voltage.

Other objectives and advantages of the invention will be understood by the following description and will also be appreciated by the embodiments of the invention more clearly.

### BRIEF DESCRIPTION OF THE DRAWINGS

FIG. 1 is a block diagram of a conventional internal voltage generator.

FIG. 2 is a detailed circuit diagram of the reference voltage generator shown in FIG. 1.

FIG. 3 is a diagram of simulation results of input/output signals of the reference voltage generator depicted in FIG. 1.

FIGS. 4A to 4C are waveform diagrams for describing a level displacement of the core voltage generated according to the prior art.

FIG. 5 is a block diagram of an internal voltage generator in accordance with a preferred embodiment of the present invention.

FIG. 6 is a detailed circuit diagram of the first and the second reference voltage generators shown in FIG. 5.

FIG. 7 is a diagram of simulation results of the input/output signals of the first reference voltage generator depicted in FIG. 6.

FIGS. 8A and 8B are waveform diagrams for describing a level displacement of the core voltage generated according to the present invention.

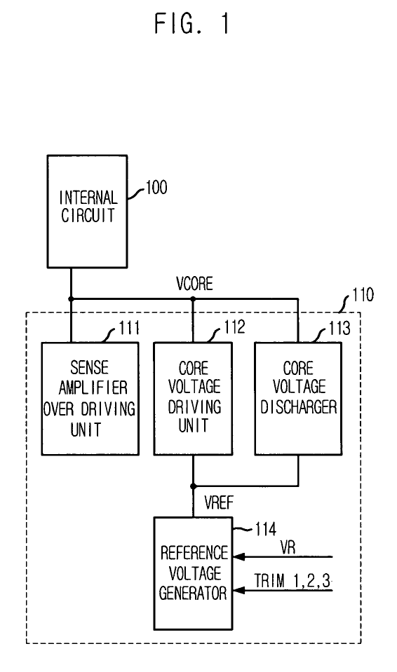

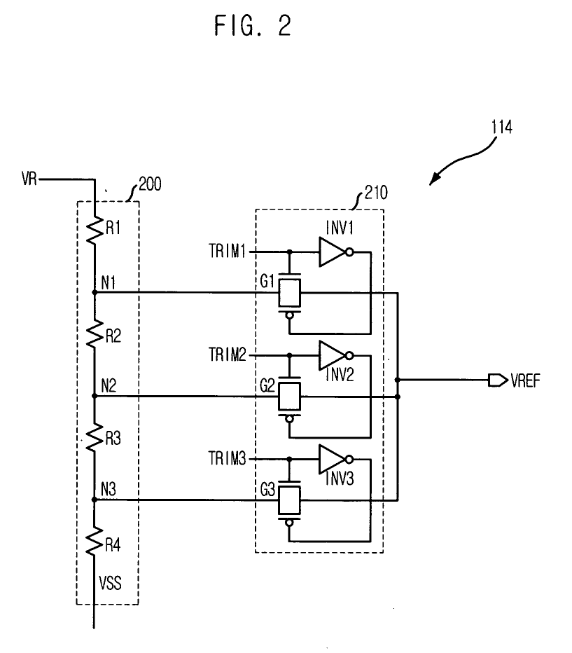

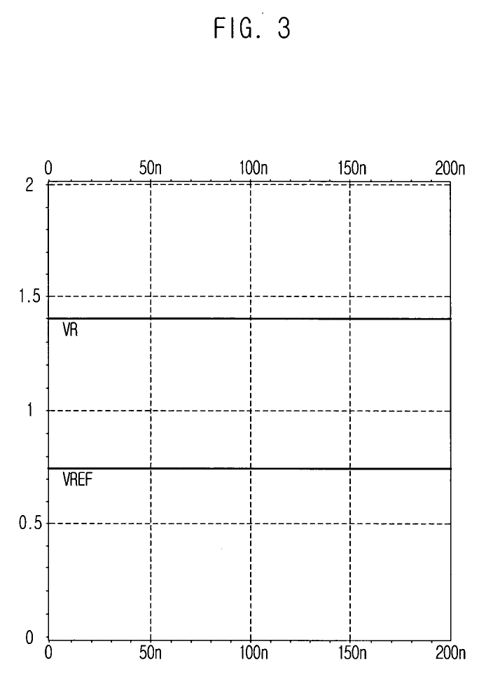

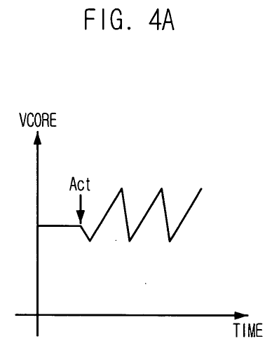

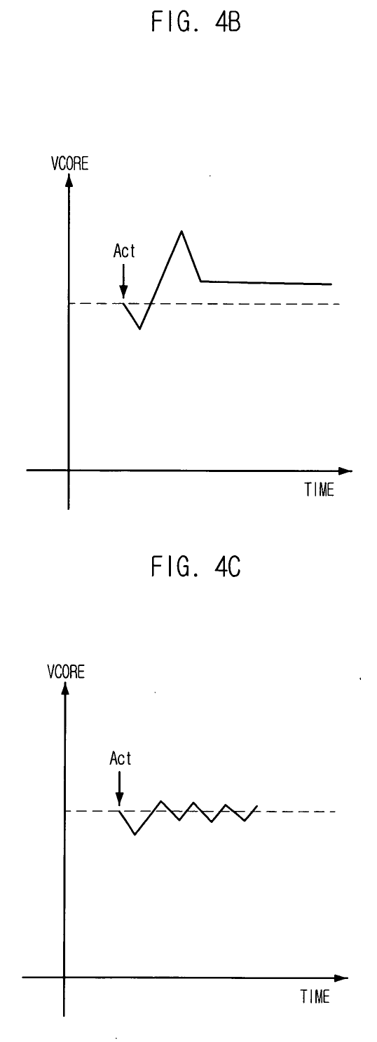

### DESCRIPTION OF SPECIFIC EMBODIMENTS

Hereinafter, preferred embodiments of the present invention will be set forth in detail with reference to the accompanying drawings.

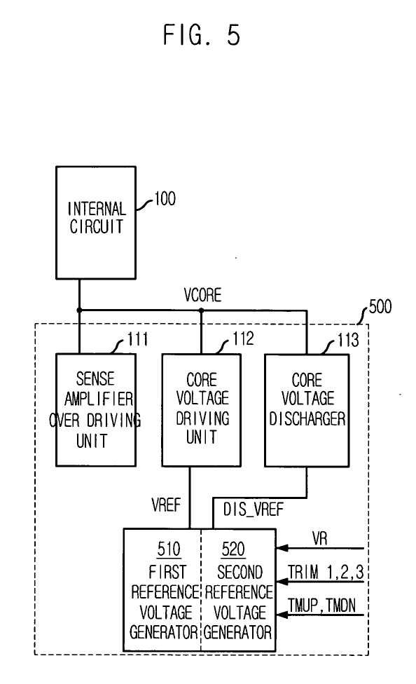

FIG. 5 is a block diagram for explaining an internal voltage generator in accordance with a preferred embodiment of the present invention.

Referring to FIG. 5, the internal voltage generator 500 includes an internal circuit 100, a sense amplifier over driving unit 111, a core voltage driving unit 112, a core voltage discharger 113, and a first and a second reference voltage generator 510 and 520.

In this configuration, since the internal circuit 100, the sense amplifier over driving unit 111, the core voltage driving unit 112, and the core voltage discharger 113 are substantially identical to those described earlier, a detailed explanation thereof will be omitted here for simplicity. Hereinafter, the first and the second reference voltage generators 510 and 520 that are related to the present invention will be described in detail.

An internal reference voltage VR is a high voltage that may vary with a process. The internal reference voltage VR is divided by a semiconductor device to provide several reference voltages. Control signals TRIM1, TRIM2 and TRIM3 are control signals for receiving the variable internal reference voltage VR and generating a supply reference voltage VREF of a predetermined voltage level (which is half of a target core voltage) and a discharge reference voltage DIS_VREF. Here, although there are provided only three control signals TRIM1, TRIM2 and TRIM3 for convenience of explanation, they may be varied in number depending on the circuit configuration.

The supply reference voltage VREF generally has a ½ voltage level of the required target core voltage VCORE (hereinafter, “half core voltage”). And, the discharge reference voltage DIS_VREF that is one of the features of the invention has a voltage level value higher than the supply reference voltage VREF by a level that takes into account the response speed delay of the core voltage discharger 230. Further, the discharge reference voltage DIS_VREF has a voltage level set to a required voltage level depending on an amount of current supplied to the core voltage end. The discharge reference voltage DIS_VREF is then provided to the core voltage discharger 113. A rise test signal TMUP and a drop test signal TMDN are signals for rising or dropping the discharge reference signal DIS_VREF to a predetermined voltage level.

In the above configuration, the sense amplifier over driving unit 111 serves to have a short circuit between an external power supply voltage VDD and the core voltage end and then apply the external power supply voltage VDD directly to the core voltage end so that the sufficient core voltage VCORE is supplied to the internal circuit 100 when an activation signal Act (not shown) for activating the operation of DRAM is applied thereto.

The core voltage driving unit 112 compares the supply reference voltage VREF with the half core voltage and charges the core voltage VCORE when the half core voltage is lower than the supply reference voltage VREF.

The core voltage discharger 113 compares the discharge reference voltage DIS_VREF with the half core voltage and discharges the core voltage VCORE when the half core voltage is higher than the discharge reference voltage DIS_VREF.

The first reference voltage generator 510 divides the internal reference voltage VR to provide the predetermined supply reference voltage VREF in response to the control signals TRIM1, TRIM2 and TRIM3.

The second reference voltage generator 520 divides the internal reference voltage VR to provide the predetermined discharge reference voltage DIS_VREF in response to the control signals TRIM1, TRIM2 and TRIM3. Further, the generator 520, in response to the rise test signal TMUP and the drop test signal TMDN, rises or drops the discharge reference voltage DIS_VREF by a desired level to a set voltage level.

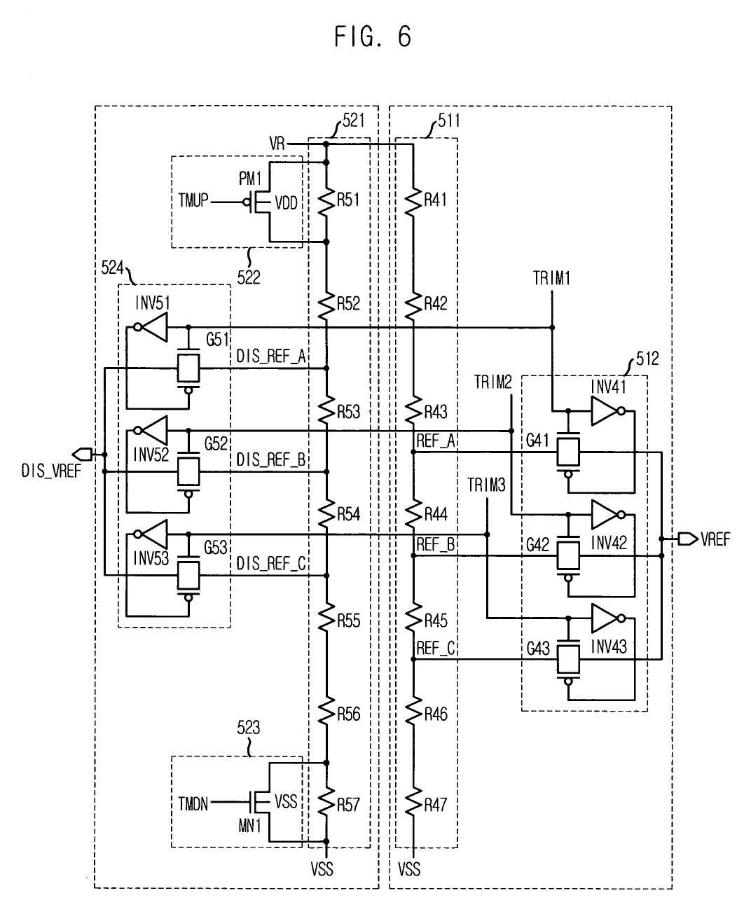

FIG. 6 is a detailed circuit diagram of the first and the second reference voltage generators 510 and 520 shown in FIG. 5.

With reference to FIG. 6, the first reference voltage generator 510 is provided with a first voltage divider 511 for dividing the internal reference voltage VR, and a first reference voltage output unit 512 for providing the predetermined supply reference voltage VREF to the core voltage driving unit 112 in response to the control signals TRIM1, TRIM2 and TRIM3.

More specifically, the first voltage divider 511 is composed of a plurality of resistors R41 to R47 connected in series between the internal reference voltage VR and a ground voltage VSS, and provides different divided voltages to each of nodes REF_A, REF_B and REF_C.

The first reference voltage output unit 512 is composed of inverters INV41 to INV43 and transfer gates G41 to G43 corresponding to the respective nodes REF_A, REF_B and REF_C. Here, the transfer gates G41 to G43 provide one of the divided voltages generated at each of the nodes REF_A, REF_B and REF_C to the core voltage driving unit 112 as the supply reference voltage VREF in response to each of the control signals TRIM1, TRIM2 and TRIM3.

The second reference voltage generator 520 is provided with a second voltage divider 521 for dividing the internal reference voltage VR, a voltage rise unit 522 for rising the divided voltages generated by the second voltage divider 521 by a desired voltage level and setting the risen voltage, a voltage drop unit 523 for dropping the divided voltages from the second voltage divider 521 by a desired voltage level and setting the dropped voltage, and a second reference voltage output unit 524 for providing the divided voltages to the core voltage discharger 113 as the discharge reference voltage DIS_VREF in response to the control signals TRIM1, TRIM2 and TRIM3.

The second voltage divider 521 is composed of a plurality of resistors R51 to R57 connected in series between the internal reference voltage VR and the ground voltage VSS, and provides different divided voltages onto each of nodes DIS_REF_A, DIS_REF_B and DIS_REF_C. Each of the resistors R51 to R57 of the second voltage divider 521 has the same resistance value as that of each of the resistors R41 to R47 of the first voltage divider 511. That is, the resistor R51 has the same resistance value as that of the resistor R41, and the other resistors in the second voltage divider 521 also have the same resistance values as those of the corresponding resistors in the first voltage divider 511.

The voltage rise unit 522 is a switching circuit connected in parallel with the resistor R51, and is composed of a PMOS transistor PM1 that receives the rise test signal TMUP via its gate. And, the voltage drop unit 523 is a switching circuit connected in parallel with the resistor R57, and is composed of an NMOS transistor NM1 that receives the drop test signal TMDN via its gate.

The second reference voltage output unit 524 is provided with inverters INV51 to INV53 and transfer gates G51 to G53 corresponding to the respective nodes DIS_REF_A, DIS_REF_B and DIS_REF_C. The transfer gates G51 to G53 provide any one of the divided voltages generated at each of the nodes DIS_REF_A, DIS_REF_B and DIS_REF_C to the core voltage discharger 113 in response to each of the control signal TRIM1, TRIM2 and TRIM3.

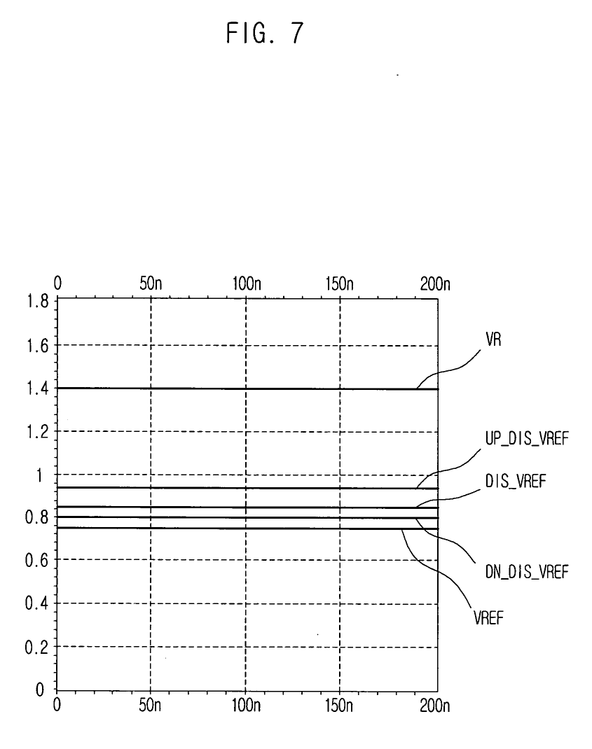

FIG. 7 is a diagram of simulation results of the input/output signals of the first reference voltage generator 510 depicted in FIG. 6.

In FIG. 7, there are provided the internal reference voltage VR, the supply reference voltage VREF, the discharge reference voltage UP_DIS_VREF risen by the voltage rise unit 522, the discharge reference voltage DN_DIS_VREF dropped by the voltage drop unit 253, and the discharge reference voltage DIS_VREF when the voltage rise unit 522 and the voltage drop unit 523 are not used.

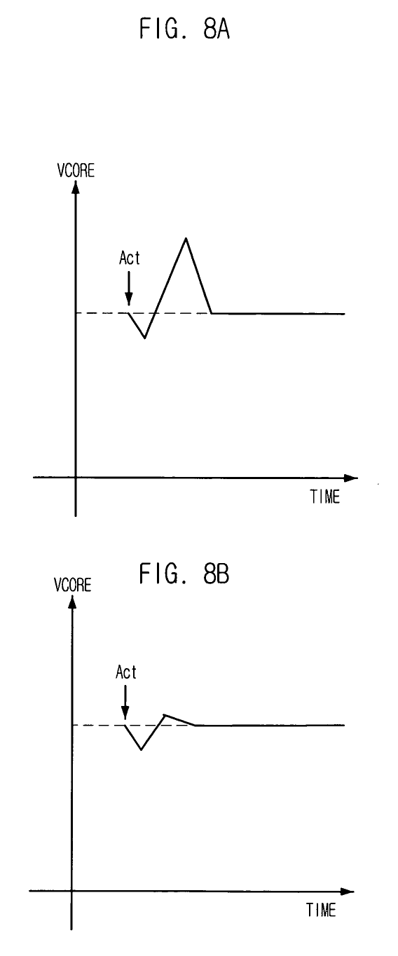

FIGS. 8A and 8B are waveforms for describing a voltage level displacement of the core voltage VCORE generated according to the present invention.

In operation, referring to FIGS. 6 and 8A, the internal reference voltage VR is divided by the first and the second voltage dividers 511 and 521 to generates divided voltage onto each of the nodes REF_A, REF_B, REF_C, DIS_REF_A, DIS_REF_B and DIS_REF_C. The control signals TRIM1, TRIM2 and TRIM3 are used to select the node REF_A, REF_B, or REF_C which generates the required supply reference voltage VREF among the divided voltages, and to provide the voltage at the selected node to the core voltage driving unit 112. At this time, the second voltage divider 520, which is in response to the same control signals TRIM1, TRIM2 and TRIM3, generates the discharge reference voltage DIS_VREF higher than the core reference voltage VREF by a predetermined voltage level, and then provides the same to the core voltage discharger 113.

For example, if the control signal TRIM1 is logic high, the voltage level at the node REF_A is output as the supply reference voltage VREF, and the voltage level at the node DIS_REF_A with voltage level higher than the core reference voltage VREF is provided as the discharge reference voltage DIS_VREF. At this time, the control signals TRIM2 and TRIM3 become logic low. Similarly, the voltage level at the node REF_B or REF_C is output as the supply reference voltage VREF, and the voltage level at the corresponding node DIS_REF_B or DIS_REF_C is provided as the discharge reference voltage DIS_VREF.

In other words, the discharge reference voltage DIS_VREF has a voltage level higher than that of the supply reference voltage VREF. A difference of voltage levels between the discharge reference voltage DIS_VREF and the supply reference voltage VREF represents a difference that is set by considering the response speed of the core voltage discharger 113.

This voltage difference can be further controlled by the voltage rise unit 522 and the voltage drop unit 523. That is, if an excessive current is supplied to the core voltage end, the drop test signal TMDN becomes logic high and thus the NMOS transistor NM1 is turned on. Due to this, the divided voltages generated at each of the nodes DIS_REF_A, DIS_REF_B, and DIS_REF_C are dropped by a predetermined voltage level.

As a result, the discharge reference voltage DIS_VREF output from any one of the nodes DIS_REF_A, DIS_REF_B and DIS_REF_C is also dropped by the predetermined voltage level. Due to this, the current excessively supplied to the core voltage end is further discharged by the discharge reference voltage DIS_VREF having a lower voltage level than the prior art by that voltage value, thereby maintaining the stable core voltage VCORE.

FIG. 8B shows a case that a current supplied to the core voltage end is slightly more than a current used in the internal circuit 100. In this case, the rise test signal TMUP becomes logic low and thus the PMOS transistor PM1 is turned on. On that account, the divided voltage generated at each of the nodes DIS_REF_A, DIS_REF_B and DIS_REF_C is risen by a predetermined voltage level. Thus, the discharge reference voltage DIS_VREF output from any one of the nodes DIS_REF_A, DIS_REF_B and DIS_REF C is also risen by the predetermined voltage level. As a result, a current supplied to the core voltage end is less discharged by the discharge reference voltage DIS_VREF having a higher voltage level than the prior art by that voltage value, thereby maintaining the stable core voltage VCORE.

As described above, the present invention applies the discharge reference voltage DIS_VREF that takes account of the response speed of the core voltage discharger 113 thereto, which renders the stable operation possible in discharging and maintaining the core voltage VCORE. Further, the discharge reference voltage DIS_VREF is risen or dropped by the desired level depending on the rise test signal TMUP and the drop test signal TMDN, and then provided to the core voltage discharger 113. Accordingly, it is possible to perform more stable operation in discharging and maintaining the core voltage VCORE.

As a result, the present invention applies a discharge reference voltage higher than a supply reference voltage to a core voltage discharger, thereby maintaining the core voltage more rapidly and stably without an unnecessary charge/discharge operation. Further, since the discharge reference voltage can be set to a required voltage level by a test signal, the required discharge reference signal can be generated without any design change or additional process.

While the present invention has been described with respect to the specific embodiments, it will be apparent to those skilled in the art that various changes and modifications may be made without departing from the spirit and scope of the invention as defined in the following claims.

What is claimed is:

1. An internal voltage generator for use in a semiconductor device, comprising:
a core voltage end;
a first reference voltage generator for generating a first reference voltage;
a second reference voltage generator including a test/option processor for generating a second reference voltage having a voltage level higher than that of the first reference voltage and setting the second reference voltage to one of a plurality of voltage levels;
a core voltage driving unit for driving a voltage at the core voltage end based on the first reference voltage; and
a core voltage discharger for discharging the voltage at the core voltage end based on the second reference voltage.

2. The internal voltage generator as recited in claim 1, wherein the second reference voltage generator includes:
a second voltage divider for dividing an internal reference voltage to produce the second reference voltage;
the test/option processor for rising or dropping the second reference voltage by a predetermined voltage level and setting the risen or dropped second reference voltage; and
a second reference voltage output unit for outputting the second reference voltage to the core voltage discharger in response to control signals.

3. The internal voltage generator as recited in claim 2, wherein the test/option processor includes:
a second reference voltage rise unit for rising the second reference voltage by the predetermined voltage level; and
a second reference voltage drop unit for dropping the second reference voltage by the predetermined voltage level;

4. The internal voltage generator as recited in claim 3, wherein the second voltage divider comprises a plurality of resistors connected in series between the internal reference voltage and a ground voltage.

5. The internal voltage generator as recited in claim 4, wherein the second reference voltage rise unit comprises a first switching circuit that is connected in parallel with the plurality of resistors arranged between the internal reference voltage and the second reference voltage, and operated in response to a rise test signal.

6. The internal voltage generator as recited in claim 5, wherein the first switching circuit is comprised of a PMOS transistor that receives the rise test signal via a gate.

7. The internal voltage generator as recited in claim 4, wherein the second reference voltage drop unit comprises a second switching circuit that is connected in parallel with the plurality of resistors disposed between the ground voltage and the second reference voltage, and operated in response to a drop test signal.

8. The internal voltage generator as recited in claim 7, wherein the second switching circuit is comprised of an NMOS transistor that receives the drop test signal via a gate.

9. The internal voltage generator as recited in claim 4, wherein the second reference voltage output unit provides any one of a plurality of voltage levels generated at nodes formed between the plurality of resistors to the core voltage discharger.

10. The internal voltage generator as recited in claim 9, wherein the second reference voltage output unit comprises a transfer gate for transferring a voltage level at one of the nodes in response to the control signals as the second reference voltage.

11. The internal voltage generator as recited in claim 2, wherein the first reference voltage generator includes:
a first voltage divider for dividing the internal reference voltage to produce the first reference voltage; and
a first reference voltage output unit for outputting the first reference voltage to the core voltage driving unit in response to the control signals.

12. The internal voltage generator as recited in claim 11, wherein the first voltage divider comprises a plurality of resistors connected in series between the internal reference voltage and a ground voltage.

13. The internal voltage generator as recited in claim 12, wherein the plurality of resistors of the first voltage divider have the same resistance values as the resistance values of the corresponding resistors in the second voltage divider, respectively.

14. The internal voltage generator as recited in claim 13, wherein the first reference voltage output unit provides any one of a plurality of voltage levels generated at nodes formed between the plurality of resistors to the core voltage discharger.

15. The internal voltage generator as recited in claim 13, wherein the first reference voltage output unit comprises a transfer gate for transferring a voltage level at one of the nodes in response to the control signals as the first reference voltage.
